(19) United States
(12) Patent Application Publication
(10) Pub. No.: US 2014/0040208 A1
(43) Pub. Date: Feb. 6, 2014

(54) EARLY RELEASE OF TRANSACTION LOCKS BASED ON TAGS

(71) Applicants: Goetz Graefe, Madison, WI (US); Hideaki Kimura, Providence, RI (US); Harumi Kuno, Cupertino, CA (US)

(72) Inventors: Goetz Graefe, Madison, WI (US); Hideaki Kimura, Providence, RI (US); Harumi Kuno, Cupertino, CA (US)

(21) Appl. No.: 13/562,906

(22) Filed: Jul. 31, 2012

(51) Int. Cl. G06F 7/00; G06F 17/30

(52) U.S. Cl. 707/648; 707/E17.007

(57) ABSTRACT

A computing system is associated with a first transaction and a second transaction. The first transaction is associated with an update to data and a release of at least one lock on the data prior to the first transaction being durable. The at least one lock is associated with and/or replaced with at least one tag. The computing system is to identify that the second transaction is to acquire the at least one tag based on a read of the data, determine whether the first transaction is durable based on the at least one tag, and delay a transaction commit for the second transaction until the first transaction is durable.

### BACKGROUND

Data systems such as databases, key-value stores, file systems, data management systems, data stores, and/or other systems can manage and process data based on data transactions. A data transaction is a logical unit of one or more operations, such as requests to access or write, performed on data. The transaction may be treated in a coherent and reliable way independent of other transactions. Database transactions acquire locks and log commit records in order to ensure consistency. A system of locks may be used to enable data operations to be atomic, consistent, isolated and durable. A lock is a synchronization mechanism for governing access to a resource when there are multiple concurrent threads of execution. A transaction may hold a lock for exclusive access (e.g., write access) to locked data until the lock is released. There are many types of locks, including shared locks (e.g., for read access).

A lock for a transaction may be released after the transaction is committed, that is, after all changes made to the transaction data are made permanent. When a transaction completes, a commit record is written to non-volatile storage, and the transaction releases locks that it holds. Thus, a transaction may be considered durable/committed when a commit log record is generated and flushed, i.e., written to stable (e.g., non-volatile) storage.

Releasing the locks after the commit record has been flushed to the permanent log ensures that other transactions do not encounter uncommitted data. However, waiting for log flushing to stable storage also increases lock hold time significantly, particularly for in-memory workloads where the log commit is the longest part of many transactions. Writing the commit log record for a given transaction may be more time consuming than executing the transaction itself. If a transaction acquires locks at the start of the transaction and holds the locks until the transaction is committed, the transaction may retain the locks while it is executing and during commit processing, i.e., after the transaction logic is complete. Given this inefficiency between transaction execution vs. committing, basic Early Lock Release (ELR) may allow a transaction to release its locks as soon as a commit record is allocated in a log buffer that is eventually to be committed to stable storage. That is, transaction locks may be released before the commit record is flushed into stable storage and before the transaction becomes durable. Basic ELR may enable a reduction of lock contention and improve performance. However, basic ELR also may produce incorrect results, e.g., incorrect data updates, if it fails to register and respect commit dependencies among participating transactions. Basic ELR may not fully optimize distributed transactions (e.g., if multiple replicas are maintained). Furthermore basic ELR may violate serializability (e.g., lack strong transaction isolation) for a database system. For example, basic ELR of exclusive (write) locks might lead to committed read-only transactions that read data that never has been completely committed (e.g., where data is rolled back in the event of a crash).

### BRIEF DESCRIPTION OF THE DRAWINGS/FIGURES

FIG. 1 is a block diagram of a computing system including a transaction manager according to an example.

FIG. 2 is a block diagram of a computing system including a transaction manager, lock manager, and recovery log according to an example.

FIG. 3 is a block diagram of a computing system including a transaction manager according to an example.

FIG. 4 is a block diagram of a computing system including a transaction manager according to an example.

FIG. 5 is a table illustrating early lock release for a first transaction and a second transaction in view of a crash according to an example.

FIG. 6 is a table illustrating pseudocode for a transaction commit according to an example.

FIG. 7 is a flow chart based on delaying transaction commit according to an example.

### DETAILED DESCRIPTION

Database transactions may acquire locks and log commit records to ensure consistency in a database system. When a transaction completes, a commit record is written to non-volatile storage, then the transaction releases any locks it holds. Reliable transactions in databases, file systems, key-value stores, etc. require a recovery log on “stable storage,” e.g., a non-volatile and/or mirrored disk. Log records in the recovery log describe all data updates and successful transaction completion (commit). All log records including the commit log record must be written to stable storage prior to acknowledgement of durability guarantees to the user or application. Releasing the locks only after the commit record has been flushed to the permanent log ensures that other transactions do not encounter uncommitted data, but also increases lock hold time significantly, particularly for in-memory workloads where the log commit is the longest part of many transactions. In contrast to waiting to release locks, locks may be released immediately after a commit log record has been appended to the log page currently being filled in the output buffer, without waiting for a flush to stable storage. Basic Early-Lock Release (ELR) may enable a committing transaction to release a held database lock early, allowing other transactions to acquire these locks immediately and continue executing. However, basic ELR may violate serializability.

Serializability is a notion of correctness for concurrent transactions. It dictates that a sequence of interleaved actions for multiple committing transactions must correspond to some serial execution of the transactions, as though there were no parallel execution at all. Serializability is a way of describing the desired behavior of a set of transactions. Serializability may be enforced by the DBMS concurrency control model (locking). Accordingly, it is desirable for early lock release to be serializable and efficient (fully serializable ELR).

Examples described herein may include various components and features. Some of the components and features may be removed and/or modified without departing from a scope of the method, system, and non-transitory computer readable medium for providing serializable ELR for data transactions. It is also appreciated that numerous specific details are set forth to provide a thorough understanding of the examples. However, it is appreciated that the examples may be practiced without limitation to these specific details. In other instances, well known methods and structures may not be described in detail to avoid unnecessarily obscuring the description of the examples. Also, the examples may be used in combination with each other. As used herein, a component is a combination of hardware and software executing on that hardware to provide a given functionality. Thus, examples provided herein (e.g., serializable/safe ELR, SX-ELR) may enable ELR to correctly apply to all locks while ensuring serializability for database systems. Lock retention times can be minimized for all locks. Lock retention times (and thus contention) may be reduced by a factor 1,000 in a case where “stable storage” for the recovery log is realized with traditional disks. If realized with semiconductor storage, e.g., a flash disk, the advantage might be a factor 10 to 100.

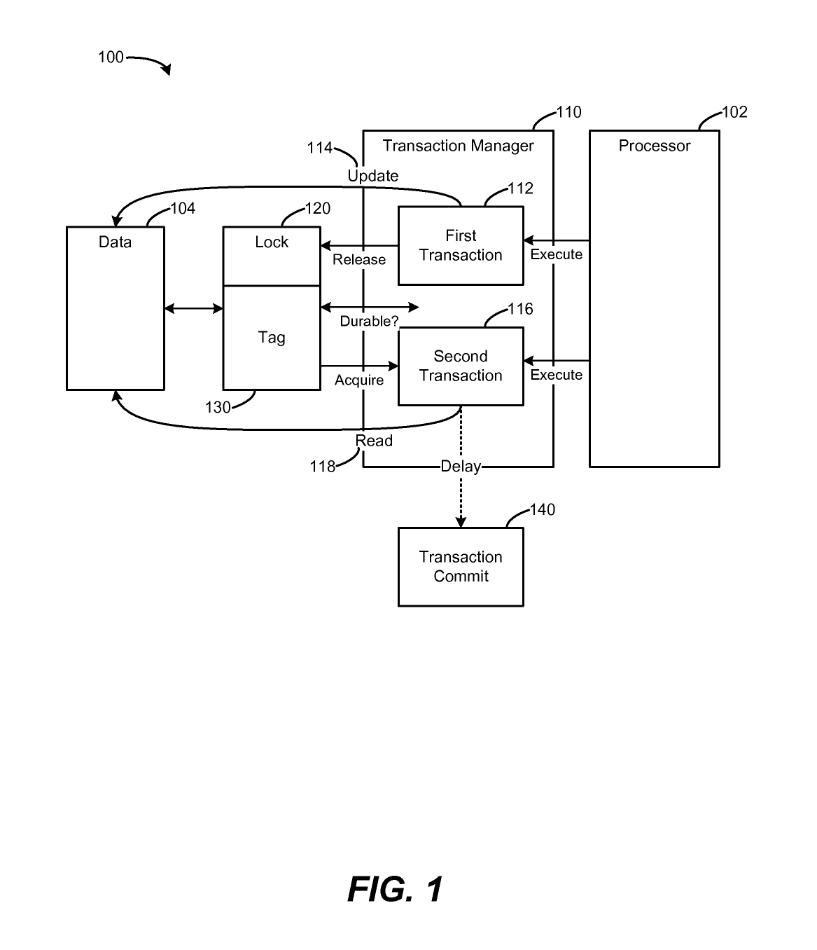

FIG. 1 is a block diagram of a computing system 100 including a transaction manager 110 according to an example. Computing system 100 also includes a processor 102 to execute a transaction. Computing system 100 is to interact with data 104 based on at least one lock 120. The transaction manager 110 is associated with first transaction 112 and second transaction 116. First transaction 112 is to perform an update 114 on data 104, and release lock 120. Second transaction 116 is to acquire lock 120 and/or tag 130, and perform read 118 on data 104. The transaction manager 110 may check durability based on tag 130, and determine whether to delay transaction commit 140.

In an example, the transaction manager 110 is to replace the at least one lock 120 by the at least one tag 130. The transaction manager 110 can identify that the second transaction 116 is to acquire the at least one tag 130 based on a read of the data 104, the data 104 also being associated with the first transaction 112. The transaction manager 110 can then determine whether the first transaction 112 is durable based on the at least one tag 130, and delay the transaction commit 140 for the second transaction 116 until the first transaction 112 is durable. In an example, the first transaction 112 is to become durable when its transaction commit has been stored in stable (e.g., non-volatile) storage. The tag 130 may include additional information, including information regarding a transactional state or other information associated with a lock or other components of computing system 100.

Examples provided herein may selectively delay commitment of read-only transactions such as second transaction 116, based on whether tag 130 is encountered for the data 104 to be read. When the read-only second transaction 116 attempts to commit based on transaction commit 140, the second transaction 116 may observe a current tail of a recovery log (e.g., the tail based on a log sequence number (LSN) in a log output buffer). The transaction may then wait until the recovery log has been written to stable storage (e.g., flushed) up to or beyond a log position indicated in the tag. Various components may be used to observe and delay the features of computing system 100, such as transaction manager 110, processor 102, a lock manager (not shown in FIG. 1) and other components.

An example commit sequence for a read-only (query) transaction may be implemented as follows, permitting fully serializable Early Lock Release for update transactions, as well as read transactions and others: start the read transaction, read data after acquisition of appropriate shared (read) locks, observe current tail position of the recovery log, release all locks, wait for observed tail to be written to stable storage, acknowledge transaction completion to user or application, and end the transaction. Implementing serializable ELR for update transactions ensures that other transactions, such as write/update transactions, also may be serializable, such that all transactions in a database system do not violate serializability.

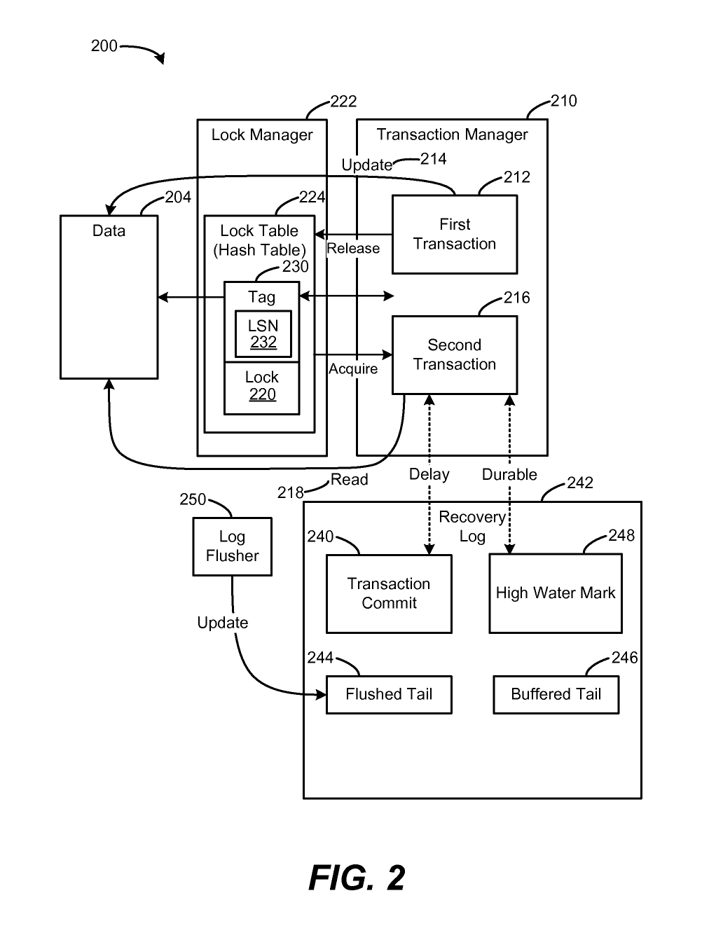

FIG. 2 is a block diagram of a computing system 200 including a transaction manager 210, lock manager 222, and recovery log 242 according to an example. The transaction manager 210 is associated with first transaction 212 and second transaction 216. First transaction 212 is to perform an update 214 on data 204, and release lock 220. Second transaction 216 is to acquire lock 220 and/or tag 230, and perform read 218 on data 204. The transaction manager 210 may check durability based on tag 230, and determine whether to delay transaction commit 240. The tag 230 may be based on Log Sequence Number (LSN) 232, and the tag 230/lock 220 may be kept in a lock table 224.

When a transaction has completed all of its tasks and/or updates, then the transaction also has logged all the tasks/updates in the recovery log 242. When it comes time to finish the transaction, a commit record (e.g., transaction commit 240) is written into the recovery log 242. The recovery log 242 may be a log buffered to memory and/or stored in stable storage to keep a record of changes made to data 204, including commit log records such as transaction commit 240. In an example, records stored in the recovery log 242 may be identified by a unique ID referred to as a Log Sequence Number (LSN). The recovery log 242 may be implemented, for example, in a log manager (not shown) or other component of computing system 200. The recovery log 242 is to maintain the durability of committed transactions, for facilitating the rollback of aborted transactions to ensure atomicity, and for recovering from system failure (a crash) or non-orderly shutdown. To provide these features, the log manager may maintain a sequence of log records on stable storage (e.g., on disk), and a set of data structures in volatile memory (e.g., random-access memory (RAM)). To support correct behavior after a crash, the memory-resident data structures associated with transactions and data are re-creatable from persistent data in the recovery log 242 and/or other components of a database system such as computing system 200.

If at least a portion of the recovery log 242 survives a crash (survives to indicate that a transaction has completed and/or has committed), the recovery log 242 will be considered when recovering the database. The transaction commit 240 in the recovery log 242 is important for recovering the database. A transaction can still fail before the transaction commit record is in the recovery log 242 as stable storage and therefore durable. Before reaching durability, the transaction may be considered by default to be a failure, and if there is a database crash, the database is recovered by rolling back such failed transactions according to the recovery log 242. Thus, a transaction may be rolled back if not yet durable, causing data related to the transaction to similarly be rolled back to a prior state. A decisive factor for durability may be whether there is a transaction commit 240 record in the recovery log 242.

The lock manager 222 may include lock table 224 to maintain the at least one lock 220. The lock table 224 may be maintained globally to hold lock names and their associated information. For efficient lookups, hashing may be used within the hash table 224 in the lock manager 222. The lock table 224 may be a dynamic hash table keyed by, e.g., a hash function of lock names. A mode flag may be associated with each lock to indicate the lock mode, and a wait queue of lock request pairs (transactionID, mode). The tag 230 may replace, be attached to, and/or may be associated with a lock 220, a class of locks 220, and/or a group of locks 220. The tag 230 may be associated with a bucket of locks 220, or otherwise placed in the hash table 224 to enable a transaction to encounter the tag 230. A hash bucket, in the context of hash indexing, may be used to implement the lock table 224 of the lock manager 222.

The first transaction 212, after completing and committing, may leave behind the tag 230 in the lock table 224, such that subsequent second transaction 216 may acquire lock 220 and/or tag 230 previously held by the first transaction 212 that has already completed. The second transaction 216 is to encounter the tag 230, based on interacting with data 204, lock manager 222, and/or other components. If the second transaction 216 encounters and/or acquires the tag 230, then the second transaction 216 is to delay committing, so as not to become durable before the first transaction 212 has become durable. For example, the second transaction 216 is to delay its transaction commit 240 until the flushed tail 244 has caught up to a value and/or position of the buffered tail 246 that is indicated in the tag 230. In other words, the second transaction 216 is to delay committing until the recovery log 242 has been flushed up to a point where the first transaction 212 is committed to stable storage.

Use of tag 230 enables a transaction to acquire the same lock that was previously held by an already completed transaction, and be informed of the commit status of the already completed transaction, based on the tag 230. The tag 230 may use a point of reference such as a LSN for determining whether a transaction is durable. LSN 232 associated with tag 230 may be used to determine whether a flushed position of the recovery log is far enough along, based on, e.g., an integer check between LSN 232 and an LSN for the flushed tail 244 and/or an LSN for the buffered tail 246. For example, the recovery log 242 may include a latest/current LSN corresponding to entries that have been buffered (e.g., the buffered tail 246) prior to being flushed to stable storage. The recovery log 242 also may include a durable LSN corresponding to entries that have been flushed to stable storage (e.g., the flushed tail 244). An LSN also may be used to indicate a high water mark 248. For example, the high water mark 248 may be used to indicate the highest among several LSNs corresponding to multiple transactions associated with data 204, such that a second transaction 216 may encounter the high water mark 248 and delay transaction commit 240 until the LSN of the flushed tail 244 is greater than or equal to the high water mark 248. The high water mark 248 may be used, for example, with pipelined transactions or other transactions having some dependency with each other. Although LSNs are provided as examples, other indicators may be used to track the buffered, flushed, and or other positions corresponding to the recovery log 242 and its relationship to entries being flushed to stable storage or otherwise being made durable. Log flusher 250 may be awakened to flush entries to stable storage and thereby update and/or advance a position of the flushed tail 244. The log flusher 250 may be awakened based on various situations, including being awakened by the delay of the transaction commit 240. For example, the transaction manager 210 may wake the log flusher 250 when a transaction commit delay is encountered, thereby causing the flushed tail 244 to be advanced as portions of the recovery log 242 are flushed from memory (buffer) to stable storage.

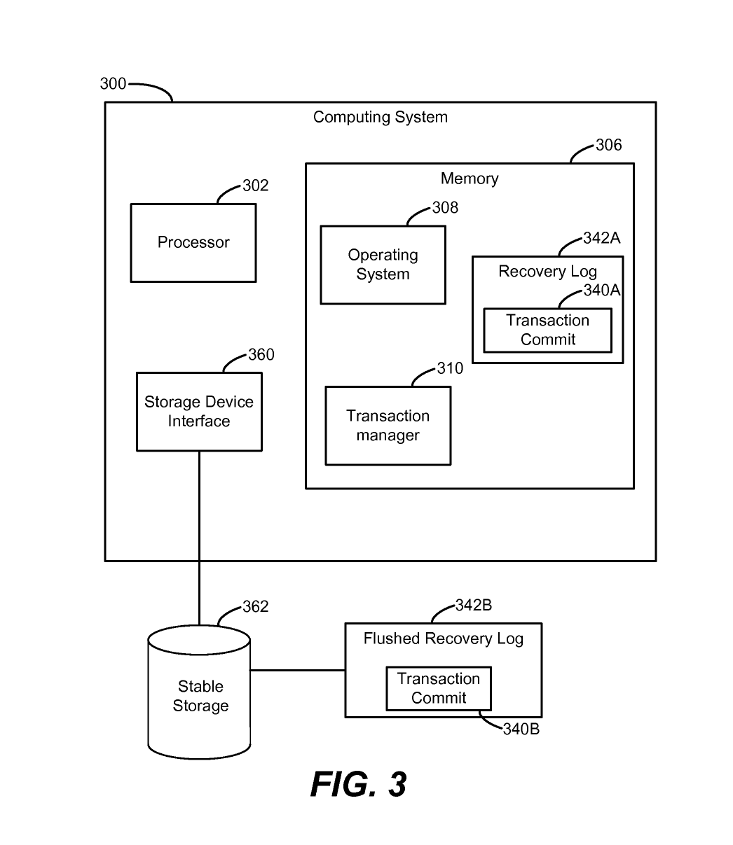

FIG. 3 is a block diagram of a computing system 300 including a transaction manager 310 according to an example. The computing system 300 also may include a processor 302, memory 306, and storage device interface 360. The memory 306 of computing system 300 may be associated with operating system 308, buffered recovery log 342A, and buffered transaction commit 340A. The storage device interface 360 is to interface with stable storage 362, such as one or more non-volatile volumes. The stable storage 362 may be associated with a flushed recovery log 342B and flushed transaction commit 340B.

In an example, a transaction completes and provides a transaction commit 340A to be buffered in the buffered recovery log 342A of the memory 306. The buffered transaction commit 340A is subsequently made durable when the buffered recovery log 342A is flushed to stable storage 362 as a flushed transaction commit 340B in the flushed recovery log 342B located on stable storage 362.

Processor 302 may be any combination of hardware and software that executes or interprets instructions, data transactions, codes, or signals. For example, processor 302 can be a microprocessor, an Application-Specific Integrated Circuit (ASIC), a distributed processor such as a cluster or network of processors or computing device, or a virtual machine.

Storage device interface 360 is a module in communication with processor 302. Computing device 300 may communicate via the storage device interface 360 (e.g., to exchange symbols or signals representing data or information) with at least one stable storage 362. Stable storage 362 is to store a number of data resources that may be organized in databases, key-value stores, data stores, and so on. Storage device interface 360 may include hardware (e.g., pins, connectors, or integrated circuits) and software (e.g., drivers or communications stacks). For example, storage device interface 360 can be a Parallel AT Attachment (PATA) interface, a Serial AT Attachment (SATA) interface, a Small Computer Systems Interface (SCSI) interface, a network (e.g., Ethernet, Fiber Channel, InfiniBand, Internet Small Computer Systems Interface (iSCSI), Storage Area Network (SAN), or Network File System (NFS)) interface, a Universal Serial Bus (USB) interface, or another storage device interface. Storage device interface 360 can also include other forms of memory, including non-volatile random-access-memory (NVRAM), battery-backed random-access memory (RAM), phase change memory, and so on.

Memory 306 is a processor-readable medium that stores instructions, codes, data, or other information. For example, memory 306 can be a volatile random access memory (RAM), a persistent or non-transitory data store such as a hard disk drive or a solid-state drive, or a combination thereof or other memories. Furthermore, memory 306 can be integrated with processor 302, separate from processor 302, or external to computing device 300.

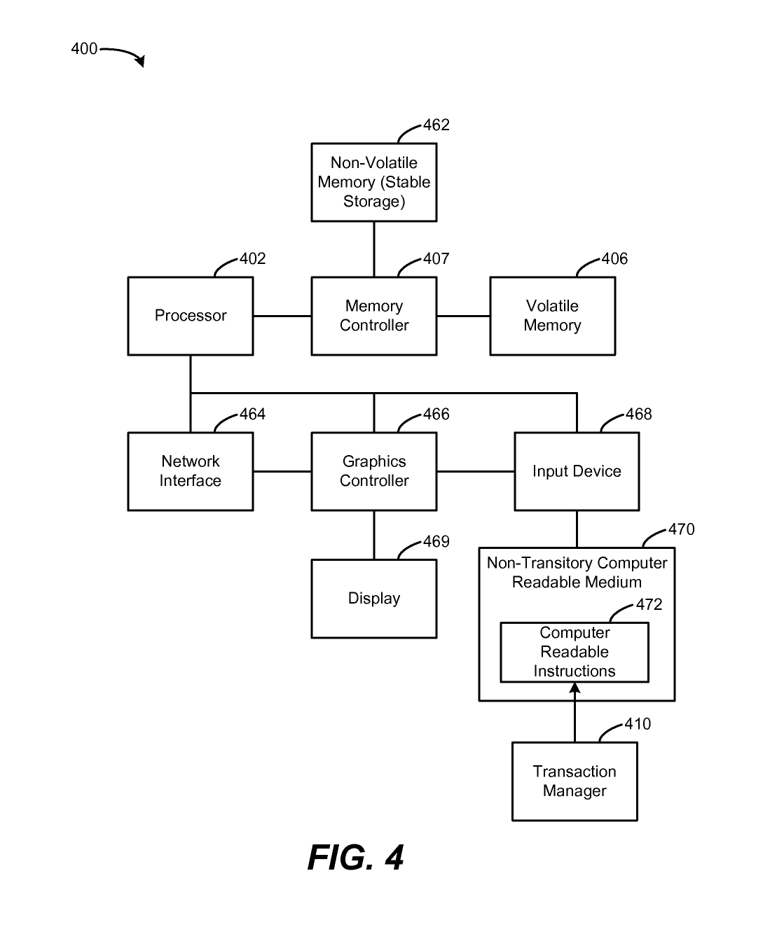

Operating system 308 and transaction manager 310 may be instructions or code that, when executed at processor 302, cause processor 302 to perform operations that implement operating system 308 and transaction manager 310. In other words, operating system 308 and transaction manager 310 may be hosted at computing device 300. More specifically, transaction manager 310 may include code or instructions that implement the features discussed above with reference to FIGS. 1 and 2, for example. Additionally, transaction manager 310 may include code or instructions that implement features discussed with reference to FIGS. 4-7.

In some implementations, transaction manager 310 (and/or other components, such as the recovery log and others disclosed throughout) may be hosted or implemented at a computing device appliance (or appliance). That is, the transaction manager 310 and/or other components may be implemented at a computing device that is dedicated to hosting the transaction manager 310. For example, the transaction manager 310 can be hosted at a computing device with a minimal or “just-enough” operating system. Furthermore, the transaction manager 310 may be the only, exclusive, or primary software application hosted at the appliance.

In some implementations, recovery log 342A is to temporarily store information (e.g., logs) about changes made to data resources stored in stable storage 362. As a specific example, recovery log 342A is to temporarily store a transaction commit 340A for a given data transaction before being written to a flushed recovery log 342B in stable storage 362. In some implementations, recovery log 342A is not included in memory 306 and records may be written directly to flushed recovery log 342B.

FIG. 4 is a block diagram of a computing system 400 including a transaction manager 410 according to an example. Examples described herein may be implemented in hardware, software, or a combination of both. Computing system 400 may include a processor 402 and memory resources, such as, for example, the volatile memory 406 and/or the non-volatile memory 462, for executing instructions stored in a tangible non-transitory medium (e.g., volatile memory 406, non-volatile memory 462, and/or computer readable medium 470). The non-transitory computer-readable medium 470 can have computer-readable instructions 472 stored thereon that are executed by the processor 402 to implement transaction manager 410 according to the present examples.

A machine (e.g., computing system 400) may include and/or receive a tangible non-transitory computer-readable medium 470 storing a set of computer-readable instructions 472 (e.g., software) via an input device 468. As used herein, the processor 402 can include one or a plurality of processors such as in a parallel processing system. The memory 406 can include memory addressable by the processor 402 for execution of computer readable instructions. The computer readable medium 470 can include volatile and/or non-volatile memory such as a random access memory (RAM), magnetic memory such as a hard disk, floppy disk, and/or tape memory, a solid state drive (SSD), flash memory, phase change memory, and so on. In some embodiments, the non-volatile memory 462 can be a local or remote database including a plurality of physical non-volatile memory devices.

The processor 402 can control the overall operation of the computing system 400. The processor 402 can be connected to a memory controller 407, which can read and/or write data from and/or to volatile memory 406 (e.g., random access memory (RAM)). The processor 402 can be connected to a bus to provide communication between the processor 402, the network interface 464, and other portions of the computing system 400. The non-volatile memory 462 can provide persistent data storage for the computing system 400. Further, the graphics controller 466 can connect to a display 469.

A computing system 400 can include a computing device including control circuitry such as a processor, a state machine, ASIC, controller, and/or similar machine. As used herein, the indefinite articles “a” and/or “an” can indicate one or more than one of the named object. Thus, for example, “a processor” can include one or more than one processor, such as in a multi-core processor, cluster, or parallel processing arrangement.

The present disclosure is not intended to be limited to the examples shown herein, but is to be accorded the widest scope consistent with the principles and novel features disclosed herein. For example, it is appreciated that the present disclosure is not limited to a particular configuration, such as computing system 400. The various illustrative modules and steps described in connection with the examples disclosed herein may be implemented as electronic hardware, computer software, or combinations of both. Examples may be implemented using software modules, hardware modules or components, or a combination of software and hardware modules or components. Thus, in an example, one or more of the example steps and/or blocks described herein may comprise hardware modules or components. In another example, one or more of the steps and/or blocks described herein may comprise software code stored on a computer readable storage medium, which is executable by a processor.

To clearly illustrate this interchangeability of hardware and software, various illustrative components, blocks, modules, and steps have been described generally in terms of their functionality (e.g., the transaction manager 410). Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

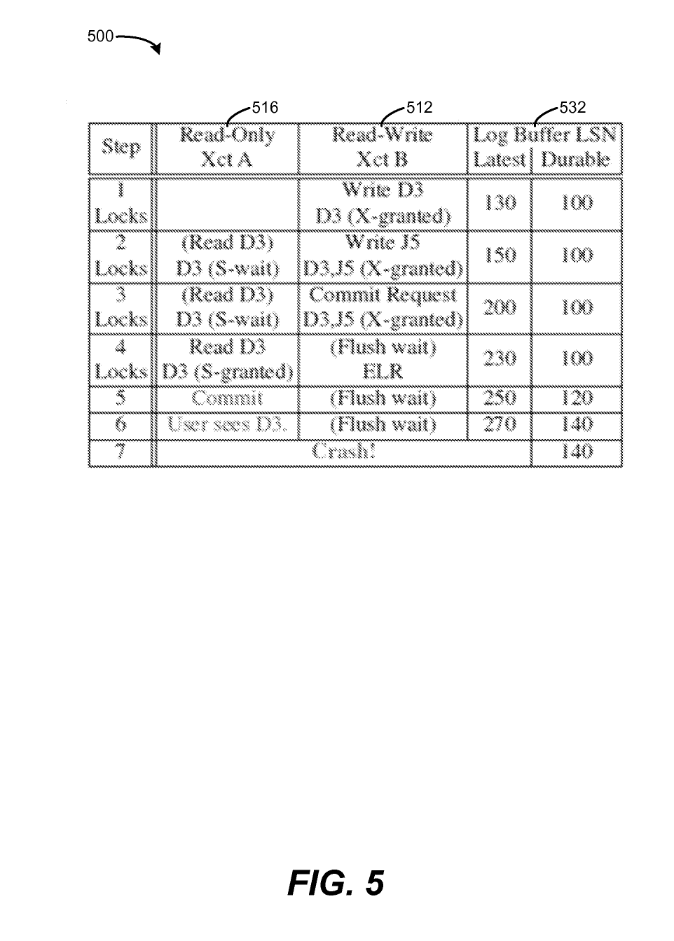

FIG. 5 is a table 500 illustrating early lock release for a first transaction 512 (Xct B) and a second transaction 516 (Xct A) in view of a crash according to an example. A basic ELR will be described with reference to FIG. 5, to illustrate an anomaly involving a non-serializable result. An exemplary ELR (e.g., safe SX-ELR) will then be described to illustrate results that do not violate serializability.

With reference to FIG. 5, consider a read-only second transaction 516, Xct A, and a read-write first transaction 512, Xct B. When B updates data (writes to tuple D3) in step 1, the uncommitted data is protected by an X lock until B's commit, shown at step 4 by an ELR to release the X lock right after B requests commit at step 3. Meanwhile, at step 2, Xct A proceeds to read D3 as updated/written by Xct B, and proceeds to immediately commit that updated value (i.e., become durable at step 5) without a log flush, because Xct A (second transaction 516) is a read-only transaction, and basic ELR allows for a read-only transaction to commit and become durable without log flush. Accordingly, the read of D3 is shown to have succeeded based on a commit of the second transaction 516 at Step 5. Thus, a read of already-updated D3 has been performed after the write to update D3. However, the commit log of Xct B has not yet been flushed, as indicated by the flush wait at steps 4-6. If a crash happens as indicated at step 7, prior to the flush succeeding, Xct B will be rolled back during recovery to a pre-write status. In other words, after the crash, D3 will be reverted back to is pre-updated value, which differs from the value for D3 already committed by the second transaction 516 at step 5. Thus, the user sees a post-updated value for D3 at step 6, even though D3 is eventually rolled back to pre-updated status following the crash at step 7. The read of D3 was committed based on a post-write value for D3. Thus, the value of D3 according to the second transaction 516 (Xct A) is different than the value of D3 according to rolling back the first transaction 512. In other words, the user already received D3, based on the read of second transaction 516 updated by Xct B, which is not a serializable result, because D3 ultimately was rolled back because of the crash at step 7. The commit of the second transaction 516 was not delayed to ensure that the first transaction 512 was durable. As illustrated, the first transaction 512 did not ever become durable, leading to the violation of serialilzability wherein the value for D3 was incorrectly read.

This anomaly associated with basic ELR can cascade arbitrarily if subsequent operations are carried out based on the result of Xct A, e.g., inserting the updated value of D3 into another database even though D3 will subsequently be rolled-back to a different value. The anomaly may cross multiple databases that depend on each other for consistency. The root problem of basic ELR as described herein (e.g., failure to selectively delay read transactions based on a tag), is that a read-only transaction did not interact with a log, thus simply doing basic ELR in this manner allows interaction with uncommitted data that might yet roll back during recovery after a system failure.

One potential fix for the above anomaly in basic ELR would be to make all read-only transactions wait for the log buffer flush before returning results. For example, the second transaction 516 (Xct A) could check the latest LSN 532 of the log buffer as of Xct A's own commit time (when LSN=250, as shown at step 5 where Xct A commits). Xct A could then wait until the log buffer makes all logs up to that LSN durable (e.g., flushes all logs to stable storage). However, this would essentially mean that all read-only transactions would have to do log flushes even when they have not touched any uncommitted data. This would substantially slow down all read-only queries, because a typical read-only query finishes within micro-seconds but would have to wait for a log flush that takes at least several milliseconds on hard disks. Instead, if another concurrent and ad hoc (not in flush-pipeline) read-only transaction Xct C (not shown) reads only committed data, Xct C should then immediately return the results without log flush because Xct C would not have touched any uncommitted data.

Another potential fix would be to check the maximum page LSN that each read-only transaction touched (e.g., when LSN=130), and wait until that LSN becomes durable. However, even if the particular update operation log becomes durable, the dependent transaction (Xct B) might be later rolled back if its commit log is not yet durable. Thus, such a fix may lead to violations in serializability.

According to principles described herein, an exemplary serializable ELR may establish that a read-only transaction (e.g., second transaction 516, Xct A) is to wait until the log flush of other transactions (e.g., first transaction 512, Xct B) that the second transaction 516 depends upon. The wait/delay may be based on a tag. In the above case, second transaction 516 (Xct A) is to wait until a durability of the log buffer's LSN 532 corresponds to B's commit log, which is when the durable log buffer LSN 532 reaches LSN=200. Notice that Xct A is to wait until 200, when the commit request at step 3 would become durable, not 130 (corresponding to the LSN of the write to D3 itself). In other words, the read transaction could be delayed when interacting with uncommitted data to allow the data to commit, and would not need to be delayed when interacting with untouched and/or already committed data. As shown in FIG. 5, the crash at step 7 occurred when LSN=140, thus Xct A would have still been waiting until LSN=200 before committing, thereby ensuring serializability.

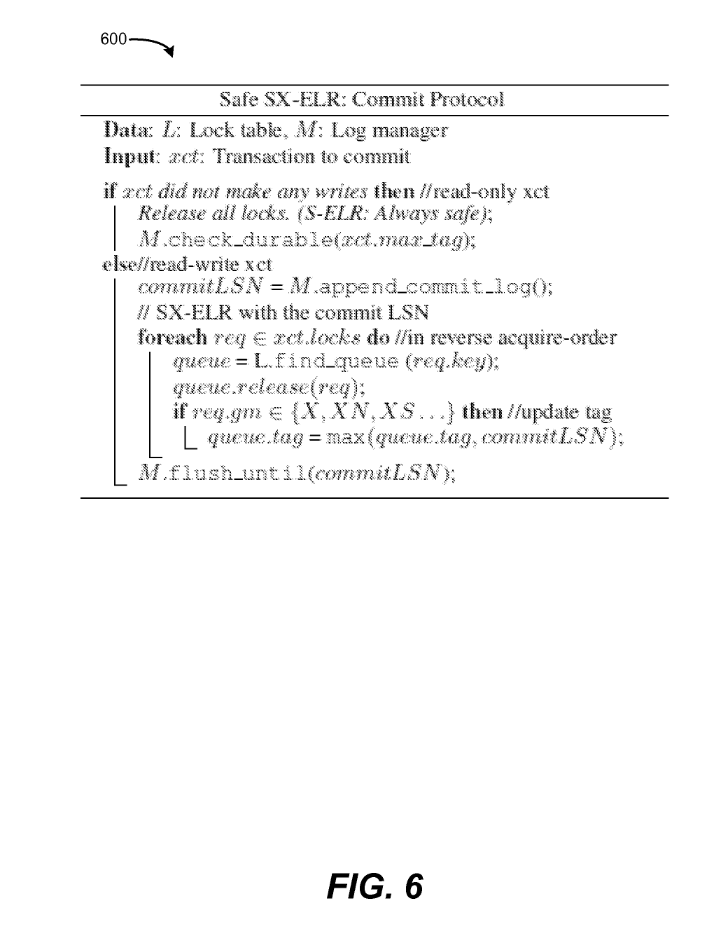

FIG. 6 is a table 600 illustrating pseudo code for a transaction commit according to an example. Based on the observations above, an example solution for serializable/safe ELR (SX-ELR) is described in the commit protocol shown in FIG. 6. Although steps are described in terms of being carried out by various components, it is possible for any component (e.g., a transaction manager) to carry out a step. The solution shown in FIG. 6 may involve associating a tag with each lock queue in the lock table. For example, the tag may be appended to a lock, and/or the tag may replace the lock. The tag is to annotate when the latest durable modification happened to the data protected by the lock. A transaction may check for such tags whenever it acquires a lock, and the maximum value of the tags it observed may be stored. When the transaction turns out to be read-only at commit time, it may compare the maximum tag with the durable LSN and immediately exit if the maximum tag is already durable. Otherwise, the transaction may wake up the log flusher and wait until the LSN becomes durable. In other words, the maximum tag is the serialization point of the read-only transaction. If the thread is pipelining a next transaction, a maximum tag (commit LSN if the current transaction is read-write) may be inherited to the next transaction, anticipating the case where the next transaction is also read-only.

Read-write transactions, in contrast, may update the tags with their commit log's LSN when they release X locks during SX-ELR. In the above example illustrated in FIG. 5, the first transaction 512 (Xct B) may update the tag(s) associated with D3 and J5 with the value 200, corresponding to a commit LSN for the first transaction 512. This may be required for X locks, which imply logical data update done by the transaction. The same rule may apply to coarse locks (e.g., volume-lock) with an additional descendant tag. The descendant tag may be updated when early releasing SIX or IX locks while the other tag (self tag) may be updated when early-releasing absolute X locks. Transactions that take intent locks (e.g., IS) check the self-tag while those that take absolute locks (e.g., S) check both the self and descendant tags.

The above techniques do not incur additional overhead penalties because the techniques may involve one simple integer comparison during lock acquisition and release. System transactions for maintenance database operations (e.g., defragmentation) may ensure that the pages they are cleaning do not have any uncommitted data. This may be done by tracking the starting LSN of the oldest active transaction in the system, and comparing it with the page LSN.

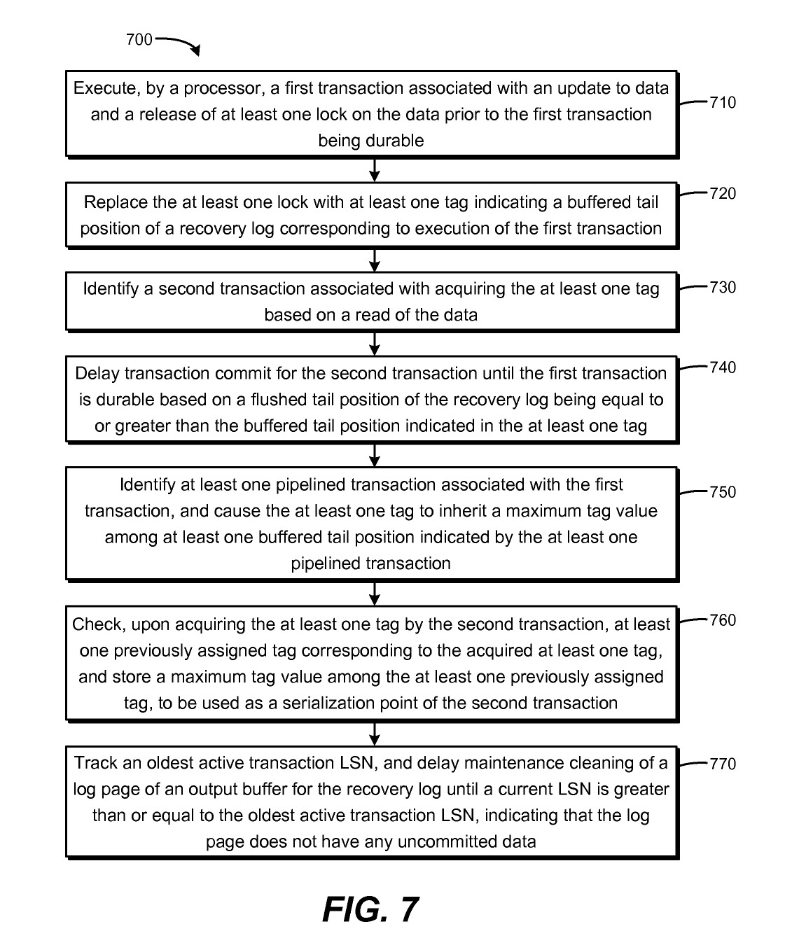

FIG. 7 is a flow chart 700 based on delaying transaction commit according to an example. In block 710, a processor is to execute a first transaction associated with an update to data and a release of at least one lock on the data prior to the first transaction being durable. For example, the first transaction may be a write transaction to change the value of data. In block 720, the at least one lock is replaced with at least one tag indicating a buffered tail position of a recovery log corresponding to execution of the first transaction. For example, the tag indicates an LSN to which flushing of a recovery log must reach, the LSN corresponding to when the first transaction would become durable based on being flushed to stable storage. In block 730, a second transaction is identified, the second transaction associated with acquiring the at least one tag based on a read of the data. For example, the transaction manager identifies that the second transaction reads data that is uncommitted or otherwise associated with a not-yet-durable transaction, including identifying one or more dependencies upon such a transaction. In block 740, transaction commit for the second transaction is delayed until the first transaction is durable based on a flushed tail position of the recovery log being equal to or greater than the buffered tail position indicated in the at least one tag. In other words, the second transaction commit is delayed until the buffered recovery log is flushed up to or beyond a position at which the first transaction is durable. In block 750, at least one pipelined transaction associated with the first transaction is identified, and the at least one tag is caused to inherit a maximum tag value among at least one buffered tail position associated with the at least one pipelined transaction. For example, a tag may inherit a first LSN value, and the tag may be updated based on pipeline dependencies such that reads of uncommitted data in the dependency chain are avoided. In block 760, upon acquiring the at least one tag by the second transaction, at least one previously assigned tag corresponding to the acquired at least one tag is checked, and a maximum tag value among the at least one previously assigned tag is stored, to be used as a serialization point of the second transaction. In block 770, an oldest active transaction LSN is tracked, and maintenance cleaning of a log page of an output buffer for the recovery log is delayed until a current LSN is greater than or equal to the oldest active transaction LSN, indicating that the log page does not have any uncommitted data. Thus, the tag may provide additional benefits to a computing system, including maintenance or other procedures that may be affected based on whether data is uncommitted.

1. A computing system comprising:
a processor; and
a memory resource storing instructions that, when executed by the processor, cause the processor to:
execute a first transaction associated with an update to data and a release of at least one lock on the data prior to the first transaction being durable;
replace the at least one lock with at least one tag;
identify a read request by a second transaction;
associate the at least one tag with the second transaction to read the data;
perform a comparison between one or more characteristics of the at least one tag and a recovery log associated with the data to determine whether the first transaction is durable to read; and
delay a transaction commit for the second transaction until the first transaction is durable.

2. The computing system of claim 1, wherein the at least one tag is based on a first Log Sequence Number (LSN) corresponding to the update to the data protected by the at least one lock, wherein the tag includes additional information associated with a transactional state of the data.

3. The computing system of claim 2, wherein the first LSN associated with the at least one tag establishes a high water mark for the recovery log in relation to a second LSN associated with a flushed tail of the recovery log, the high water mark corresponding to a position of the recovery log that triggers the transaction commit for the second transaction

4. The computing system of claim 1, wherein the at least one tag indicates a buffered tail position of the recovery log corresponding to execution of the first transaction, and wherein determining whether the first transaction is durable includes determining whether a current flushed tail position of the recovery log is equal to or greater than the buffered tail position indicated in the at least one tag.

5. The computing system of claim 1, wherein, in response to delaying the transaction commit, the processor wakes a log flusher to increment a flushed tail position of the recovery log.

6. The computing system of claim 1, wherein the at least one tag indicates that an early lock release (ELR) has occurred for the at least one lock, and wherein the processor associates the second transaction with the at least one tag based on the ELR.

7. (canceled)

8. The computing system of claim 1, wherein the processor delays the transaction commit based on performing an integer comparison between a first LSN of the at least one tag and a second LSN of a flushed tail of the recovery log upon acquiring or releasing the at least one lock.

9. The computing system of claim 1, wherein in response to determining that the first transaction is durable, appending a commit log record associated with the first transaction to an output buffer associated with the recovery log.

10. The computing system of claim 1, wherein the at least one lock includes an exclusive write lock corresponding to the update to the data, and the second transaction is associated with a shared read lock.

11. A computer-implemented method of managing data transactions, the method being performed by one or more processors and comprising:
executing a first transaction associated with an update to data and a release of at least one lock on the data prior to the first transaction being durable;
replacing the at least one lock with at least one tag;
identifying a read request by a second transaction;
associating the second transaction with the at least one tag to read the data;
performing a comparison between one or more characteristics of the at least one tag and a recovery log associated with the data to determine whether the first transaction is durable to read; and
delaying a transaction commit for the second transaction until the first transaction is durable.

12. The method of claim 11, wherein the at least one tag is based on a first Log Sequence Number (LSN) corresponding to the update to the data protected by the at least one lock, wherein the tag includes additional information associated with a transactional state of the data.

13. The method of claim 12, wherein the first LSN associated with the at least one tag establishes a high water mark for the recovery log in relation to a second LSN associated with a flushed tail of the recovery log, the high water mark corresponding to a position of the recovery log that triggers the transaction commit for the second transaction.

14. The method of claim 11, wherein the at least one tag indicates a buffered tail position of the recovery log corresponding to execution of the first transaction, and wherein determining whether the first transaction is durable includes determining whether a current flushed tail position of the recovery log is equal to or greater than the buffered tail position indicated in the at least one tag.

15. A non-transitory computer readable medium storing instructions that, when executed by a processor, cause the processor to:
execute a first transaction associated with an update to data and a release of at least one lock on the data prior to the first transaction being durable;
replace the at least one lock with at least one tag;
identify a read request by a second transaction;
associate the at least one tag with the second transaction to read the data;
perform a comparison between one or more characteristics of the at least one tag and a recovery log associated with the data to determine whether the first transaction is durable to read; and
delay a transaction commit for the second transaction until the first transaction is durable.

16. The method of claim 11, further comprising:
in response to delaying the transaction commit, waking a log flusher to increment a flushed tail position of the recovery log.

17. The method of claim 11, wherein the at least one tag indicates that an early lock release (ELR) has occurred for the at least one lock, and wherein the processor associates the second transaction with the at least one tag based on the ELR.

18. The method of claim 11, wherein the processor delays the transaction commit based on performing an integer comparison between a first LSN of the at least one tag and a second LSN of a flushed tail of the recovery log upon acquiring or releasing the at least one lock.

19. The method of claim 11, wherein in response to determining that the first transaction is durable, appending a commit log record associated with the first transaction to an output buffer associated with the recovery log.

20. The method of claim 11, wherein the at least one lock includes an exclusive write lock corresponding to the update to the data, and the second transaction is associated with a shared read lock.

21. The method of claim 12, further comprising:
identifying an oldest active LSN in the recovery log;
comparing the oldest active LSN to the first LSN corresponding to the update to the data;
delaying maintenance cleaning of the recovery log until the first LSN is equal to or greater than the oldest active LSN.
